(19) United States
(12) Patent Application Publication
(10) Pub. No.: US 2025/0182218 A1
(43) Pub. Date: Jun. 5, 2025

(54) METHOD AND SYSTEM FOR PROVIDING A PLATFORM TO ENABLE SOCIAL COLLABORATION IN A SINGLE THREAD IN SEAMLESS MANNER

(71) Applicant: Rajiv SINGH, Noida (IN)

(72) Inventor: Rajiv SINGH, Noida (IN)

(21) Appl. No.: 18/846,388

(22) PCT Filed: Jan. 26, 2023
(86) PCT No.: PCT/IB2023/050662

§ 371 Date: Sep. 12, 2024

(30) Foreign Application Priority Data
Mar. 17, 2022 (IN) 202211014941

(51) Int. Cl. G06Q 50/00; G06F 9/451; G06Q 20/02

(52) U.S. Cl. CPC G06Q 50/01; G06F 9/451; G06Q 20/027

(57) ABSTRACT

A technique is provided for providing a platform to enable social collaboration and resource sharing. The technique includes registering users on the platform and receiving location codes of interest to a user, basis which a set of users within a pre-defined area are identified. The identification is based on a correlation of location codes of the user and remaining registered users. Based on inputs received from the user, posts comprising information relating to the location codes are created automatically created based on artificial intelligence (AI). The created posts are shared with the identified set of users in a newsfeed to enable collaboration in sharing of resources between the user and users from the set. From a second user from the set of users, responses associated with the posts are received and a collaborative sharing of resources between the user and the second user is enabled.

### TECHNICAL FIELD

This disclosure relates generally to a social networking platform, and more particularly to a method and system for providing a platform to enable social collaboration and resource sharing.

### BACKGROUND

While there is a lot of involvement of people with political and economic issues, issues of social reform are largely neglected. However, the fact remains that social reform holds the key not only for reducing distress but also for changing personal and community/social life in ways that can provide conducive conditions for a constructive and positive approach to life, unleashing creativity and improving the world. Even when social reform may be taken up in some ways, often the more basic issues are neglected. Such trends can be seen in most parts of the world. Given rich tradition of social reform, it is unwarranted that social reform has suffered from increasing neglect in the country. Often expressed excuse for social reform is that the social reform needs social mobilization, holding meetings, contacting as many people as possible; and in times of reduced mobility brought by events such as war or pandemic, the prospects for this are lesser than before due to requirements of distancing, increased problems with commuting and related factors.

For efficacy, any social reforms should also be able to provide immediate relief to people in certain respects. Also, what we try to take forward should be broad-based and comprehensive, but at the same time it should not be complicated and complex. The initiative of social reform should be simple, something people can identify with in real life and can interpret in their own context. To this end, several discussions resulted in the identification of three basic messages, which can lead to desirable changes in society. Firstly, in a best possible effort should be made to not cause any distress to any other human being or any other life-form. Secondly, in any interaction with someone who is weaker or poorer than us, the effort should be to try and help instead of just showing how privileged we are. Thirdly, from the depth of our heart we should drop any discriminatory thinking or attitude so that we can sincerely put into practice the precept of basic equality and oneness of all human beings.

The aforementioned points being the guiding philosophy, actionable steps should accompany the aforesaid tenets. Such actions may include encouraging local unbiased and unprejudiced local connectivity between people. Steps may further include active involvement of authorities in redressal of public grievances and performing of welfare activities, such as sharing of additional resources like food/clothes and the like, with the underprivileged.

However, the aforesaid actions are hampered by lack connectivity solutions that may bridge the gaps between people. Consequently, there is an acute need for platforms that connects people basis their profiles in a manner that enables seamless transfer of resources from resource surplus zones to zones in need of resources. As an example, there are numerous businesses, individuals, homes, commercial establishments that are straddled with a problem of disposal of resource surplus, resource wastage, resource misallocation, and the like. In another example, we have seen many online platforms that function as discount stores with auctioned items, but have lost relevance in the sense that they have no societal benefit for the needy or those who are looking for super discounted bargains or those items that need immediate disposal whether or not they fetch commercial benefits.

Further, there are many organizations that have a problem of plenty in terms of their unusable raw materials, old scrap, electronic items, and many more, and are grappling storage issues among others. They would look for platforms that will help them handle such problems. These organizations may like to get brownie points or use these as corporate social responsibility (CSR) activities, at the same time solve the problem of unusable plenty. Likewise, there are many small to large local vendors that may have old items, both perishable and non-perishable that they need to dispose at residual or heavily discounted prices or even free to the needy who are on the lookout for such items. Furthermore, there may be many good Samaritan who may be willing to take up local social, political, and/or administrative issues of other and escalate for resolution and action from the local political leaders, corporators, political aficionados, local government agencies and/or officers. These could be youngsters, political aspirants, socially conscious individuals, and local non-profit organizations.

For solving all the aforesaid problems, there exists no platform where one can connect locally with each other without having mobile number, email, address, and the like. Also, there is no platform available where local issues can be raised and equally monitored for correction/execution. Further, there is no uniform print media platform like magazines, newspaper where local news, local issues, local business opportunities could be visible. There does not exist an application where government and/or administrative authorities may directly establish connection with specific area for any broadcasting and vice versa from local communities to government and/or administrative authorities. There is also, no platform that connects the real needy with donor or where the local businesses or people with used or new but sellable excess commercial, household, individual but disposable items within locality. There is no platform in which the political or local self-help groups can escalate local issues through to the appropriate officials or political leaders for fast resolution and result. There is no local commerce platform for selling excess and unusable material, items at very cheap rates to attract buyers from local areas. The sellers can be among local vendors, shops, establishments, and/or individuals who have something in excess or already used, working/non-working, scrap but usable material.

Therefore, there exists a need to provide a system and/or method using which a club member or a member of any community may overcome the above mentioned problems. Further, there is a need for an improved system and/or method that provide a platform to enable social collaboration and resource sharing.

### SUMMARY

In one embodiment, a method of providing a platform to enable social collaboration and resource sharing, is disclosed. The method includes registering, via a user interface (UI) of an application installed on an electronic device, a plurality of users on the platform based on a plurality of fields associated with each of the plurality of users. The method includes receiving of one or more location codes that may be of interest to a first user from the plurality of users may be basis which a set of users from the plurality of users within a pre-defined area to which the received one or more location codes corresponds may be identified. The identification may be based on a correlation of at least the one or more location codes of the first user and remaining users from the plurality of users. Based on one or more inputs received from the first user, one or more posts comprising information relating to the one or more location codes may be created. The one or more posts may be automatically created based on application of artificial intelligence (AI) on the received one or more inputs. The created one or more posts may be shared with the identified set of users by display of the created one or more posts in a newsfeed subscribed by the set of users, to enable collaboration in sharing of one or more resources between the first user and one or more users from the set of users. The method includes receiving, from a second user from the set of users, one or more responses associated with the created one or more posts shared in the newsfeed of the set of users. A collaborative sharing of one or more resources between the first users and the second user may be enabled based on at least the received one or more responses.

In another embodiment, a system for providing a platform to enable social collaboration and resource sharing, is disclosed. The system includes a plurality of electronic devices, each associated with a user from a plurality of users, and an application installed on each of the plurality of electronic devices. The application comprises a user interface (UI) of the platform and the application that performs registration of a plurality of users on the platform based on a plurality of fields associated with each of the plurality of users. The application performs receipt of one or more location codes that may be of interest to a first user from the plurality of users. The application performs identification of a set of users from the plurality of users within apre-defined area to which the received one or more location codes corresponds. The identification may be based on a correlation of at least the one or more location codes of the first user and remaining users from the plurality of users. The application performs creation of one or more posts comprising information relating to the one or more location codes based on one or more inputs received from the first user. The one or more posts may be automatically created based on application of artificial intelligence (AI) on the received one or more inputs. The application performs sharing of the created one or more posts with the identified set of users by display of the created one or more posts in a newsfeed subscribed by the set of users, to enable collaboration in sharing of one or more resources between the first user and one or more users from the set of users. The application performs receipt, from a second user from the set of users, of one or more responses associated with the created one or more posts shared in the newsfeed of the set of users. The application performs enablement of a collaborative sharing of one or more resources between the first users and the second user based on at least the received one or more responses.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is an exemplary network environment depicting method of providing a platform to enable social collaboration and resource sharing, in accordance with some embodiments of the present disclosure.

FIG. 2 is a block diagram of exemplary system for providing a platform to enable social collaboration and resource sharing, in accordance with some embodiments of the present disclosure.

FIG. 3 illustrates an exemplary scenario for providing a platform to enable social collaboration and resource sharing is illustrated in accordance with some embodiments of the present disclosure.

FIG. 4 illustrates an exemplary scenario for customized highlighting of the one or more posts based on relative location of the users registered with the social collaboration and resource sharing platform, in accordance with some embodiments of the present disclosure.

FIG. 5 is a flow diagram of a detailed exemplary process for providing a platform to enable social collaboration and resource sharing, in accordance with some embodiments of the present disclosure.

FIG. 6 is a block diagram of an exemplary computer system for implementing embodiments consistent with the present disclosure is illustrated.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims.

Various implementations may be found in a method and/or a system providing a platform to enable social collaboration and resource sharing, is disclosed. The disclosed invention provides a method and a system for providing a platform to enable social collaboration in a single thread in seamless manner to bring social reform by addressing grievances and empowering each of the users of the platform, such as the common man.

The method includes registering, via a user interface (UI) of an application installed on an electronic device, a plurality of users on the platform based on a plurality of fields associated with each of the plurality of users. In accordance with an embodiment, the one or more fields includes name, age, mobile number, email address, city, locality, office location, work location, user interests, user preferences. The one or more fields may be received from the plurality of users.

The method includes receiving one or more location codes that are of interest to a first user from the plurality of users. Basis the receipt of the one or more location codes, a set of users from the plurality of users within a pre-defined area to which the received one or more location codes corresponds may be identified. The identification may be based on a correlation of at least the one or more location codes of the first user and remaining users from the plurality of users. In accordance with an embodiment, the set of users includes local authorities, local volunteer organizations, local volunteer members, people seeking specific resources, people offering specific resources, auctioneers, bidders.

Based on one or more inputs received from the first user, one or more posts including information relating to the one or more location codes may be created. In accordance with an embodiment, the one or more location codes include a postal index number (PIN) code and/or an electoral constituency code. In accordance with an embodiment, the information include availability, quality, and quantity of one or more of: food, clothes, educational material, medicines, services, grievances of a populace, business opportunities, advertisements, one or more social causes that benefits the plurality of users, and financial assets.

In accordance with an embodiment, the one or more posts include a social media campaign for enabling donation of one or more items. In accordance with an embodiment, the one or more items for donation are indexed to enable searching of the one or more items on the UI by the plurality of users, based on one or more of: keywords, user utterances, images, gestures.

In accordance with an embodiment, the one or more posts include multimedia content and metadata associated with the one or more items. In accordance with another embodiment, the one or more posts include an SOS message including location code of the first user, generated for one or more authorities for providing emergency services to the first user. The one or more authorities include law enforcement agency and medical service agency.

In accordance with an embodiment, the one or more posts may be automatically created based on application of artificial intelligence (AI) on the received one or more inputs. In accordance with another embodiment, one or more polling requests may be created to obtain the one or more inputs from the plurality of users.

The created one or more posts may be shared with the identified set of users by display of the created one or more posts in a newsfeed subscribed by the set of users, to enable collaboration in sharing of one or more resources between the first user and one or more users from the set of users.

The method further includes receiving, from a second user from the set of users, one or more responses associated with the created one or more posts shared in the newsfeed of the set of users. A collaborative sharing of one or more resources between the first users and the second user may be enabled based on at least the received one or more responses. In accordance with an embodiment, the collaborative sharing includes allocation of the one or more resources from the first user to the second user, and acknowledgment provided to the first user for the allocation of the one or more resources. The acknowledgement includes monetary compensation provided to the first user for the allocated resources, wherein the compensation is one or more of: a monetary compensation, a gamified compensation. In accordance with an embodiment, the collaborative sharing between the first user and the second user includes sharing the details of the one or more authorities that can provide emergency services to the first user.

In accordance with an embodiment, one or more payment gateways may be integrated with the platform for settlement of compensation and/or raising funds from the plurality of users, which can be utilized to resolve one or more complaints raised by the plurality of users.

In accordance with an embodiment, one or more comments from the set of users on at least one of the one or more posts may be received. A color coding mechanism may be utilized to display the one or more comments based on a pre-defined criteria. In accordance with an embodiment, the pre-defined criterion includes highlighting a comment with a first color, if the comment is provided by a user that is within the one or more location codes that is of interest to the first user. In accordance with an embodiment, the pre-defined criterion includes highlighting a comment with a second color, if the comment is provided by a user that is within same city of the first user but is not located in the one or more location codes that is of interest to a user. In accordance with an embodiment, the pre-defined criterion includes highlighting a comment with a third color, if the comment is provided by a user from another city than that of the first user. In accordance with an embodiment, the pre-defined criterion includes highlighting a comment with a fourth color if the comment is provided by a user from another country than that of the first user.

In accordance with an embodiment, one or more action buttons associated with each of the one or more posts may be provided. A user from the set may click on the one or more actions buttons to like, dislike, share, and comment on the one or more posts.

In accordance with an embodiment, an option to the plurality of users may be provided to publish the one or more posts to PIN codes, city, and country, continents that are different from that of the plurality of users.

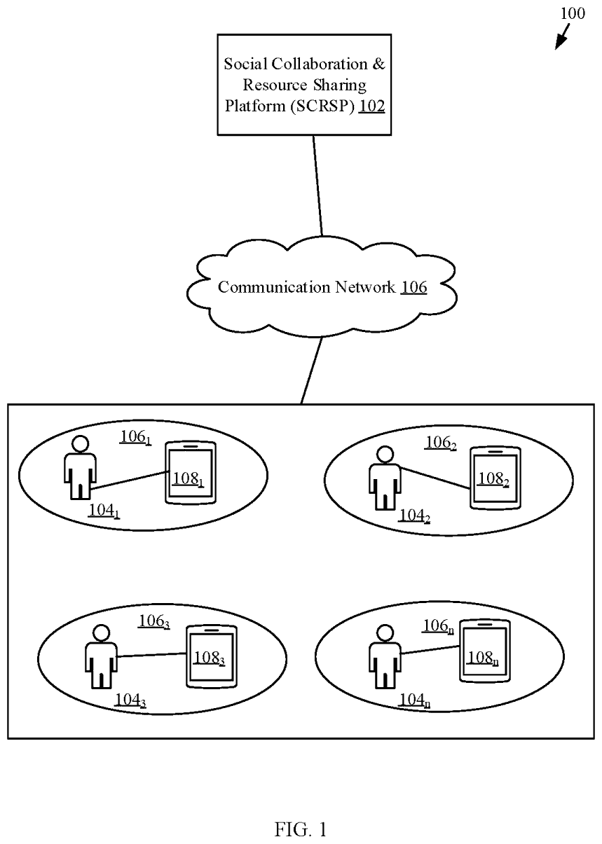

Referring now to FIG. 1, an exemplary network environment 100 method of providing a platform to enable social collaboration and resource sharing, is illustrated in accordance with some embodiments of the present disclosure. The network environment 100 displays a social collaboration and resource sharing platform (SCRSP) 102. The SCRSP 102 may be used by the plurality of users 1041 to 104n (also collectively referred as plurality of users 104). Each of the plurality of users 104 may be present in a location code from the plurality of location codes 1061 to 106n (also collectively referred as plurality of users 106). For example, the user 1041 may be present in location code 1061, the user 1042 may be present in location code 1062. The user 104n may be present in location code 106n, and so on. A location code may include, but is not limited to, a postal index number (PIN) code and/or an electoral constituency code. Such a code may also correspond to a location of a region, city, country, and the like.

The plurality of users 104 may be include an associated electronic device from a plurality of electronic devices 1081 to 108n (also collectively referred as plurality of electronic devices 108). For example, the user 1041 may be associated with the electronic device 1081, the user 1042 may be associated with the electronic device 1082, and the user 104n may be associated with the electronic device 108n, and so on.

The network environment 100 includes a network of the plurality of electronic devices 108 (e.g., a computer, a server, a digital device, a router, a modem, a bridge, a switch, etc.) for sending or receiving various data. Each of the electronic devices further includes one or more processors and a computer-readable storage medium (e.g., a memory). The computer-readable storage medium stores instructions that, when executed by the one or more processors, cause the one or more processors to perform data reception and transmission in accordance with aspects of the present disclosure. The computer-readable storage medium may also store various data (e.g., optimal network path, optimal packet size, data packets, current packet size of a node, etc.) that may be captured, processed, and/or required by the network environment 100.

In accordance with an embodiment, the plurality of electronic devices 108 may include suitable logic, circuitry, interfaces, and/or code for displaying one or more user interfaces of the community interaction platform on a display screen of the electronic device. Examples of implementation of the display screen of the electronic devices may include, but are not limited to, a Liquid Crystal Display (LCD) display, a Light Emitting Diode (LED) display, an Organic LED (OLEO) display technology.

The SCRSP 102, the plurality of users 104, and the plurality of electronic devices 108 may be communicatively coupled with each other, via a communication network 110. Examples of the communication network 110 may include, but are not limited to, the Internet, a cloud network, a Wireless Fidelity (Wi-Fi) network, a Wireless Local Area Network (WLAN), a Local Area Network (LAN), a telephone line (POTS), Long Term Evolution (LTE), and/or a Metropolitan Area Network (MAN). Various devices in the exemplary network environment 100 may be configured to connect to the communication network 110, in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), Zigbee, EDGE, infrared (IR), IEEE 802.11, 802.16, cellular communication protocols, and/or Bluetooth (BT) communication protocols.

In operation, the plurality of users 104 may be registered on the SCRSP 102 based on data provided for a plurality of fields associated with each of the user. To this end, each electronic device (such as the electronic device 1081 of the user 1041) may provide a user interface (UI) of an application installed on the electronic device, on which the data corresponding to the plurality of fields may be received from the user. Based on the received data, the plurality of users 104 may be registered on the SCRSP 102 based on a plurality of fields associated with each of the plurality of users. In accordance with an embodiment, the one or more fields includes name, age, mobile number, email address, city, locality, office location, work location, user interests, user preferences. The one or more fields may be received from the plurality of users. In accordance with an embodiment, the registration may be based on one or more validation inputs received from local authorities that govern the location code in which the user is present. For example, for registration, if the user 1041 provides an identification proof that pertains to a particular location code, the details provided by the user 1041 may be validated by the authority that issues the identification to residents of that location code.

In an embodiment, registration may be performed for individual members or organizations/local authorities/NGO and like. In an embodiment, validation may be mandatary for successful registration of the organizations/local authorities/NGO and like. In an embodiment, validation may be optional for successful registration of the individual members.

Upon successful registration, a user (such as the user 1041) from the plurality of users 104 may provide one or more location codes that are of interest to the user 1041. The one or more location codes provided on the UI of the associated electronic device 1081 may be transmitted to the SCRSP 102, via the communication network 110. In accordance with an embodiment, the one or more location codes include a postal index number (PIN) code and/or an electoral constituency code.

In accordance with an embodiment, an option to the plurality of users may be provided to publish the one or more posts to specific PIN codes, city, and country, continents that are different from that of the plurality of users. Basis the receipt of the one or more location codes, the SCRSP 102 may identify a set of users from the plurality of users 104. The identification may be such that the set of users are located within a pre-defined area to which the received one or more location codes corresponds. As an example, if the one or more location codes provided by the user 1041 include the codes 1063 and 1064, the identified set of users may include the users 1043 and 1044.

In accordance with an embodiment, the identification may be based on a correlation of at least the one or more location codes associated with the user 1041 and remaining users from the plurality of users 104. The set of users may include, but is not limited to, local authorities, local volunteer organizations, local volunteer members, people seeking specific resources, people offering specific resources, auctioneers, bidders. In accordance with an embodiment, based on the identification, a dedicated channel may be created between the user 1041 and one or more users from the identified set of users that reside in the same location code as the user 1041. The channel may serve as a virtual circle or a group which is created automatically on the SCRSP 102 and/or one or more social media profiles associated with the user 1041 and the one or more users.

Based on one or more inputs received from the user 1041, one or more posts including information relating to the one or more location codes may be created. The one or more inputs may be provided by the user 1041 on the UI of the application installed on the associated electronic device 1061. In accordance with an embodiment, the information includes availability, quality, and quantity of one or more of: food, clothes, educational material, medicines, services, grievances of a populace, business opportunities, advertisements, one or more social causes that benefits the plurality of users, and financial assets. The one or more posts includes, but are not limited to, a social media campaign for enabling donation of one or more items.

In accordance with an embodiment, the one or more items for donation may be indexed to enable searching of the one or more items on the UI by the plurality of users 104. The search may be based on inputs that include, but are not limited to, keywords, user utterances, images, gestures.

In accordance with an embodiment, the one or more posts include multimedia content and metadata associated with the one or more items. In accordance with another embodiment, the one or more posts include an SOS message including location code of the user 1041, generated for one or more authorities for providing emergency services to the first user. The one or more authorities may include, but are not limited to, law enforcement agency and medical service agency.

The creation of one or more posts may be based on application of artificial intelligence (AI) on the received one or more inputs. The AI techniques may include, but are not limited to, supervised learning, unsupervised learning, and/or reinforcement learning techniques.

In accordance with another embodiment, the SCRSP 102 may create one or more polling requests that may be rendered on the UI of the plurality of electronic devices 108, with the intent of gathering one or more inputs from the plurality of users 104 for a particular cause, campaign, societal malaise, infrastructural issue, and the like.

The SCRSP 102 may share the created one or more posts with the identified set of users by display of the created one or more posts in a newsfeed subscribed by the set of users. The one or more posts may be rendered on the UI of the electronic devices associated with the set of users. The rendered one or more posts enable collaboration in sharing of one or more resources between the user 1041 and one or more users from the set of users.

Based on the shared one or more posts, a second user (such as the user 1043) from the set of users may provide one or more responses associated with the one or more posts shared in the newsfeed of the set of users. The response may be provided on the UI of the electronic device 1083 associated with the users 1043. A collaborative sharing of one or more resources between the user 1041 and the user 1043 may be enabled based on at least the received one or more responses.

In accordance with an embodiment, the collaborative sharing includes allocation of the one or more resources from the user 1041 to the user 1043. Once the sharing is affected, the SCRSP 102 may provide acknowledgment to the user 1041 for the allocation of the one or more resources. The acknowledgement may include, but is not limited to, monetary compensation provided to the user 1041 for the allocated resources. The compensation may include one or more of a monetary compensation, a gamified compensation, loyalty points, system generated ranking, and the like.

In accordance with an embodiment, the collaborative sharing between the user 1041 and the user 1043 includes sharing the details of the one or more authorities that can provide emergency services to the user 1041.

In accordance with an embodiment, one or more payment gateways may be integrated with the platform for settlement of compensation and/or raising funds from the plurality of users 104, which can be utilized to resolve one or more complaints raised by the plurality of users.

In accordance with an embodiment, the SCRSP 102 may receive one or more comments from the set of users on the one or more posts. A color coding mechanism may be utilized by the SCRSP 102 for displaying the one or more comments based on a pre-defined criteria. In accordance with an embodiment, the pre-defined criterion includes highlighting a comment with a first color (such as GREEN), if the comment is provided by a user that is within the one or more location codes that is of interest to the first user. The pre-defined criterion includes highlighting a comment with a second color (such as ORANGE), if the comment is provided by a user that is within same city of the first user but is not located in the one or more location codes that is of interest to a user. The pre-defined criterion includes highlighting a comment with a third color (such as BLUE), if the comment is provided by a user from another city than that of the first user. In accordance with an embodiment, the pre-defined criterion includes highlighting a comment with a fourth color (such as RED) if the comment is provided by a user from another country than that of the first user.

In accordance with an embodiment, when a user (such as the user 1047) that is located in a different location code when compared to the user 1041, comments on a post shared on the newsfeed of the user 1041, the color of the post may be in accordance with the relative location of the user 1047. For example, if the location of the user 1047 is in a different country with respect to the location of the user 1041, the comment provided by the user 1047 will be depicted in the fourth color (such as RED) when displayed in the newsfeed of the user 1041.

In accordance with an embodiment, one or more action buttons associated with each of the one or more posts may be provided. A user from the set may click on the one or more actions buttons to like, dislike, share, comment on the one or more posts.

It should be noted that the various modules described above may be implemented in programmable hardware devices such as programmable gate arrays, programmable array logic, programmable logic devices, and so forth. Alternatively, the various modules described above may be implemented in software for execution by various types of processors. An identified module of executable code may, for instance, include one or more physical or logical blocks of computer instructions which may, for instance, be organized as an object, procedure, function, engine, or other construct. Nevertheless, the executables of an identified module need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for transmitting data over a communication network 108. For example, the exemplary network environment 100 may transmit data over a communication network 108 by the processes discussed herein. In particular, as will be appreciated by those of ordinary skill in the art, control logic and/or automated routines for performing the techniques and steps described herein may be implemented by the network environment 100, either by hardware, software, or combinations of hardware and software. For example, suitable code may be accessed and executed by the one or more processors on the network environment 100 to perform some or all of the techniques described herein. Similarly, application specific integrated circuits (ASICs) configured to perform some or all of the processes described herein may be included in the one or more processors on the network environment 100.

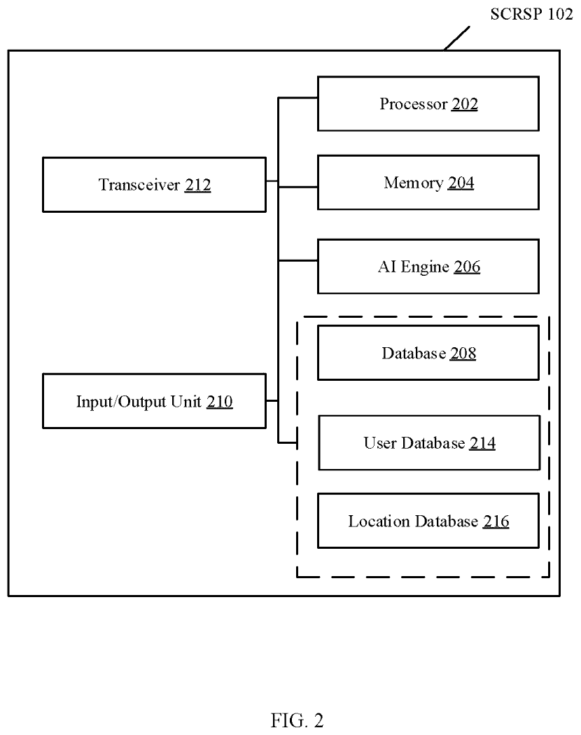

FIG. 2 is a block diagram of exemplary system for providing a platform to enable social collaboration and resource sharing, in accordance with some embodiments of the present disclosure. FIG. 2 is explained in conjunction with elements from FIG. 1. With reference to FIG. 2, there is shown the SCRSP 102 that may include one or more processors, such as a processor 202, a memory 204, an artificial intelligence (AI) engine 206, a database 208, an input/output (I/O) unit 210, and/or a transceiver 212. The SCRSP 102 provides a platform to enable social collaboration in a single thread in seamless manner to bring social reform by addressing grievances and empowering each of the users of the platform, such as the common man. The processor 202 may be communicatively coupled to the memory 204, the AI engine 206, the database 208, the I/O unit 210, and/or the transceiver 212.

The processor 202 may include suitable logic, circuitry, interfaces, and/or code that may be configured to execute a set of instructions stored in the memory 204. The processor 202 may be configured to register the plurality of users, establish communication channel between the users, and enable collaborative sharing between the plurality if users based on the one or inputs provided by the users. The processor 202 may further track the activities of the community club members and may facilitate selective sharing of data among the plurality of community clubs. Examples of the processor 202 may be an X86-based processor, a Reduced Instruction Set Computing (RISC) processor, an Application-Specific Integrated Circuit (ASIC) processor, a Complex Instruction Set Computing (CISC) processor, and/or other processors.

The memory 204 may include suitable logic, circuitry, and/or interfaces that may be configured to store a machine code and/or a computer program with at least one code section executable by the processor 202. In an embodiment, the memory 204 may be configured to one or more instructions that enable the modules, such as the AI engine 206, database 208, and the I/O unit 210 to establish a channel between the plurality of users for collaborative sharing of resources amongst the registered user. Examples of implementation of the memory 204 may include, but are not limited to, Random Access Memory (RAM), Read Only Memory (ROM), Hard Disk Drive (HOD), and/or a Secure Digital (SD) card.

The database 208 may include suitable logic, circuitry, interfaces, and/or code that may be configured to store references to each of the plurality of user 104 registered with the SCRSP 102. To this end, the database 208 may include a user database 214. The database 208 may further store information regarding the location in which a user from the plurality of user 104 is located. The information may include location codes that include, but are not limited to, a postal index number (PIN) code and/or an electoral constituency codes.

The I/O unit 210 may include suitable logic, circuitry, interfaces, and/or code that may be configured to render a UI on an application installed on the plurality of electronic devices 108 associated with the plurality of users 104. The I/O unit 210 may include various input and output devices that may be configured to communicate with a user from the plurality of user 104, via the rendered UI. It is such one or more electronic devices that, in conjunction with the I/O unit 212, may be configured to display one or more interfaces of the community interaction platform 200, the community club member or the administrative user, via a display screen. Examples of the display screen may include, but are not limited to, Liquid Crystal Display (LCD) display, Light Emitting Diode (LED) display, Organic LED (OLEO) display technology, and/or the like.

In an implementation, the I/O unit 212 may be further equipped with a photographic optical system, such as a photographic lens and/or a zoom lens, as well as one or more image sensors, such as a charge-coupled device (CCD) or a complementary metal-oxide-semiconductor (CMOS), a digital camera, a camera embedded in a personal digital assistant (PDA), a video camera, and/or a motion camera. A person of ordinary skill in the art will appreciate that the I/O unit 212 may further include one or more audio based output devices for enabling communication with a community club member or an administrative user.

The transceiver 212 may include suitable logic, circuitry, interfaces, and/or code that may be configured to facilitate communication among the plurality of user 104 and the plurality of electronic device 108. The transceiver 212 may be implemented based on known technologies to support wired or wireless communication. The transceiver 212 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer. The transceiver 212 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), code division multiple access (CDMA), Long Term Evolution (LTE), time division multiple access (TOMA), Bluetooth, Wireless Fidelity (Wi-Fi) (such as IEEE 802.11a, IEEE 802.11b, IEEE 802.11g and/or IEEE 802.11n), voice over Internet Protocol (VOIP), Wi-MAX, a protocol for email, instant messaging, and/or Short Message Service (SMS).

In operation, the plurality of users 104 may be registered on the user database 214 of the SCRSP 102 based on data provided for a plurality of fields associated with each of the user. To this end, the processor 202 in conjunction with the I/O unit 210, may be configured to instruct each electronic device (such as the electronic device 1081 of the user 1041) to provide a user interface (UI) of an application installed on the electronic device. The display may be based on the data corresponding to the plurality of fields that may be received from a user (such as the user 1041). Based on the received data, the plurality of users 104 may be registered on the user database 214 of the SCRSP 102 based on a plurality of fields associated with each of the plurality of users 104. In accordance with an embodiment, the one or more fields includes name, age, mobile number, email address, city, locality, office location, work location, user interests, user preferences. The one or more fields may be received from the plurality of users. In accordance with an embodiment, the registration may be based on one or more validation inputs received from local authorities that govern the location code in which the user is present. For example, for registration, if the user 1041 provides an identification proof that pertains to a particular location code, the details provided by the user 1041 may be validated by the authority that issues the identification to residents of that location code. In an embodiment, registration may be performed for individual members or organizations/local authorities/NGO and like. In an embodiment, validation may be mandatary for successful registration of the organizations/local authorities/NGO and like. In an embodiment, validation may be optional for successful registration of the individual members. The platform disclosed herein enables social collaboration in a single thread in seamless manner to bring social reform by addressing grievances and empowering each of the users of the platform, such as the common man.

Upon successful registration, the processor 202 in conjunction with the I/O unit 210, may be configured to receive one or more location codes that are of interest from the user 1041, via the transceiver 212. In accordance with an embodiment, the one or more location codes include a postal index number (PIN) code and/or an electoral constituency code.

In accordance with an embodiment, the processor 202 in conjunction with the I/O unit 210, may be configured to provide an option on the UI of associated electronic devices of the plurality of users 104 for publishing the one or more posts. The one or more posts may pertain to specific PIN codes, city, and country, continents that are different from that of the plurality of users. To this end, the processor 202 in conjunction with the I/O unit 210 may be configured to receive one or more location codes from the users. In accordance with another embodiment, based on the plurality if fields associated with the plurality of user 104, the processor 202 in conjunction with the user database 214, may be configured to retrieve one or more location codes that are of interest to the users (such as the user 1041).

The processor 202 in conjunction with the AI engine 206, may be configured to identify a set of users from the plurality of users 104. The identification may be such that the set of users are located within a pre-defined area to which the received one or more location codes corresponds. As an example, if the one or more location codes provided by the user 1041 include the codes 1063 and 1064, the identified set of users may include the users 1043 and 1044. The identification may be based on a correlation of at least the one or more location codes associated with the user 1041 and remaining users from the plurality of users 104. The set of users may include, but is not limited to, local authorities, local volunteer organizations, local volunteer members, people seeking specific resources, people offering specific resources, auctioneers, bidders.

In accordance with an embodiment, based on the identification, a dedicated channel may be created between the user 1041 and one or more users from the identified set of users that reside in the same location code as the user 1041. The channel may serve as a virtual circle or a group which is created automatically on the SCRSP 102 and/or one or more social media profiles associated with the user 1041 and the one or more users. The channel may serve as a persistent virtual medium using which the user 1041 and the one or more users may engage in social collaboration and resource sharing. The disclosed invention provides a method and a system for providing a platform to enable social collaboration in a single thread in seamless manner to bring social reform by addressing grievances and empowering each of the users of the platform, such as the common man.

Subsequent to identification of the set of users, one or more posts that includes information relating to the one or more location codes may be created by the AI engine 206, based on one or more inputs received from the user 1041. The one or more inputs may be provided by the user 1041 on the UI of the application installed on the associated electronic device 1061. In accordance with an embodiment, the information may include, but is not limited to, availability, quality, and quantity of one or more of: food, clothes, educational material, medicines, services, grievances of a populace, business opportunities, advertisements, one or more social causes that benefits the plurality of users, and financial assets. Further, the one or more posts may include, but are not limited to, a social media campaign for enabling donation of one or more items.

In accordance with an embodiment, the processor 202 in conjunction with the AI engine 206 may be configured to categorize one or more items for donation. Based on the categorization, the one or more items may be indexed with the intent of enabling searching of the one or more items on the UI, by the plurality of users 104. The search may be based on inputs that include, but are not limited to, keywords, user utterances, images, gestures.

In accordance with an embodiment, the one or more posts may include, but are not limited to, multimedia content and metadata associated with the one or more items. In accordance with another embodiment, the one or more posts may include, but are not limited to, an SOS message having location code of the user 1041. The sos message may be generated for one or more authorities for providing emergency services to the user (1041). The one or more authorities may include, but are not limited to, law enforcement agency and medical service agency.

The processor 202, in conjunction with the AI engine 206, may be configured to create one or more posts based on application of artificial intelligence (AI) on the received one or more inputs from the user 1041. The AI techniques may include, but are not limited to, supervised learning, unsupervised learning, and/or reinforcement learning techniques.

In accordance with another embodiment, the processor 202 may be configured to create one or more polling requests that may be rendered on the UI of the plurality of electronic devices 108. Such posts may be created with the intent of gathering one or more inputs from the plurality of users 104 for a particular cause, campaign, societal malaise, infrastructural issue, and the like.

In accordance with an embodiment, the I/O unit 210 in conjunction with the processor 202, may be configured to provide an access restricted, dedicated centralized display catering to authorities. The authorities may include, but are not limited to, departments and/or ministries. The centralized UI may be provided for identification, logging, and resolution of issues pertaining to one or more areas present under a location code, thereby enabling the authorities in having visibility of critical data while planning & executing any scheme. The centralized UI may also allow residents of a location code in directly reporting any local issue to the related authorities. This may assist different departments and/or ministries in planning for developmental projects after identification of critical gaps in facilities present in a location code. By application of techniques that include, but are not limited to AI, the processor 202 may leverage the aforesaid centralized UI in providing the entire data of a location code at one place thereby facilitating gee-location based spatial planning, development, and/or resolution of grievances. The centralized UI mentioned above enables authorities in visualizing, reviewing, and monitoring the problems (or progress) associated with a location code at various levels. The rendered centralized UI provides a real-time report of on-ground solutions to the objects and is updated by the concerned department, individual, and/or community. The display also facilitates identification of vital interventions for enhancing and updating the key initiative required at various stages.

The processor 202 may be configured to share the created one or more posts with the identified set of users. The sharing may be performed by the processor 202 in conjunction with the I/O unit 210. The shared content may be display as one or more posts in a newsfeed subscribed by the set of users. The one or more posts may be rendered on the UI of the electronic devices associated with the set of users. The rendered one or more posts enable collaboration in sharing of one or more resources between the user 1041 and one or more users from the set of users. Based on the shared one or more posts, a second user (such as the user 1043) from the set of users may provide one or more responses associated with the one or more posts shared in the newsfeed of the set of users. The response may be received by the I/O unit 210 and subsequently, a collaborative sharing of one or more resources between the user 1041 and the user 1043 may be enabled by the processor 202, based on at least the received one or more responses.

In accordance with an embodiment, the collaborative sharing includes allocation of the one or more resources from the user 1041 to the user 1043. Once the sharing is affected, the processor 202 may be configured to provide acknowledgment to the user 1041 for the allocation of the one or more resources. The acknowledgement may include, but is not limited to, monetary compensation provided to the user 1041 for the allocated resources. The compensation may include one or more of a monetary compensation, a gamified compensation, loyalty points, system generated ranking, and the like.

In accordance with an embodiment, the collaborative sharing between the user 1041 and the user 1043 includes sharing the details of the one or more authorities that can provide emergency services to the user 1041. In accordance with another embodiment, the processor 202 may further include one or more payment gateways that may be integrated with the SCRSP 102. The one or more payment gateways enable settlement of compensation and/or raising funds from the plurality of users 104, which can be utilized to resolve one or more complaints raised by the plurality of users 104.

In accordance with an embodiment, processor 202 may be configured to receive one or more comments from the set of users on the one or more posts. A color coding mechanism may be utilized by the I/O unit 210 for displaying the one or more comments based on a pre-defined criteria. In accordance with an embodiment, the pre-defined criterion includes highlighting a comment with a first color (such as GREEN), if the comment is provided by a user that is within the one or more location codes that is of interest to the first user. The pre-defined criterion includes highlighting a comment with a second color (such as ORANGE), if the comment is provided by a user that is within same city of the first user but is not located in the one or more location codes that is of interest to a user. The pre-defined criterion includes highlighting a comment with a third color (such as BLUE), if the comment is provided by a user from another city than that of the first user. In accordance with an embodiment, the pre-defined criterion includes highlighting a comment with a fourth color (such as RED) if the comment is provided by a user from another country than that of the first user.

In accordance with an embodiment, one or more action buttons associated with each of the one or more posts may be provided. A user from the set may click on the one or more actions buttons to like, dislike, share, comment on the one or more posts.

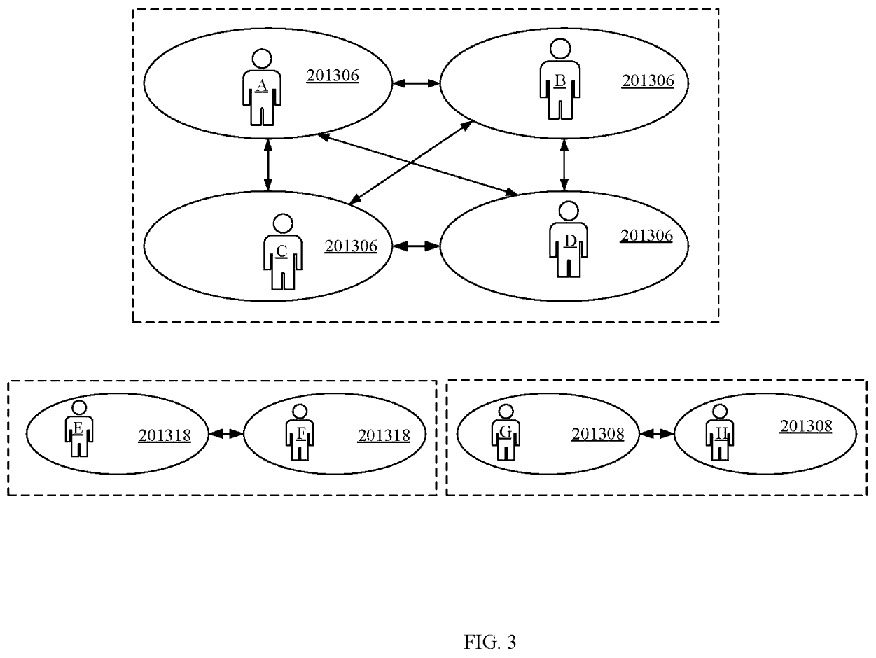

FIG. 3 illustrates an exemplary scenario for providing a platform to enable social collaboration and resource sharing is illustrated in accordance with some embodiments of the present disclosure. The elements of FIG. 3 have been described in conjunction with elements of FIGS. 1 and 2.

With reference to FIG. 3, there is shown an exemplary setup consisting of eight users (‘A’-‘H’) registered with the SCRSP 102. Among the users (‘A’-′H′), users ‘A’, ‘B’, ‘C’, ‘D’ may belong to a particular area having a location code ‘201306’, ‘E’ and ‘F’ may belong to an area having location code ‘201318’, ‘G’ and ‘H’ may belong to an area having location code ‘201308’.

In an exemplary scenario, the SCRSP 102 may be configured to enable resource sharing between the users that belong to same location code. The enablement may be such that the users shall be connected to all users that are located in the same location code. Accordingly, collaborative sharing may be enabled between the users ‘A’-‘D’, ‘E’ and ‘F’, and G and ‘H’.

In another exemplary scenario, the SCRSP 102 may receive additional location codes from the users. Such additional location codes may be indicative of location codes in which the user intend to establish a collaborative resource sharing channel. For example, the user ‘A’ may intend to share resources with the users located in the location code ‘201306’ as well as the users located in the location code ‘201308’. This information may be received from the user ‘A’ via the UI of an application installed on an electronic device associated with the user. Accordingly, basis the receipt of the preferred location codes, the SCRSP 102 may establish a collaborative resource sharing channel between the user ‘A’ and the users ‘G’ and ‘H’.

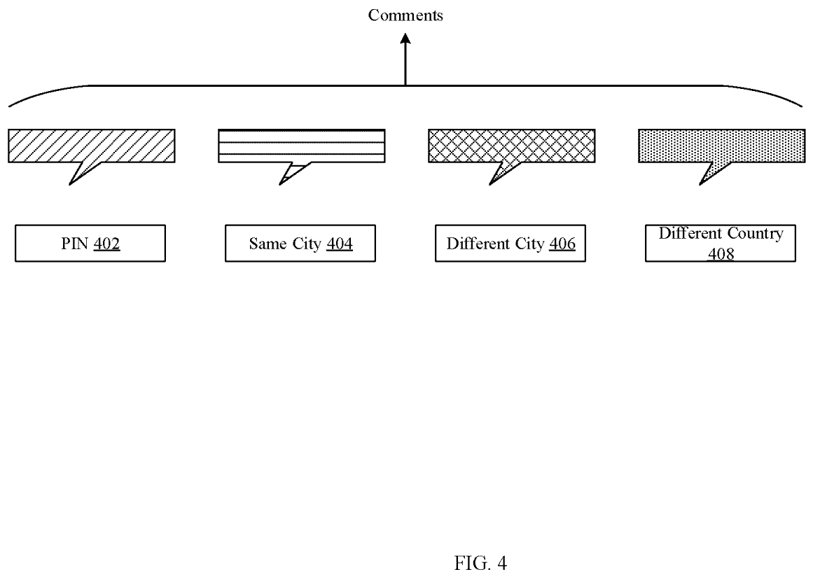

FIG. 4 illustrates an exemplary scenario for customized highlighting of the one or more posts based on relative location of the users registered with the social collaboration and resource sharing platform, in accordance with some embodiments of the present disclosure. The elements of FIG. 4 have been described in conjunction with elements of FIGS. 1 and 3.

In accordance with an embodiment, processor 202 may be configured to receive one or more comments from the set of users on the one or more posts. A color coding mechanism may be utilized by the I/O unit 210 for displaying the one or more comments based on a pre-defined criteria.

In an exemplary scenario, the pre-defined criterion includes highlighting a comment with a first color 402 (such as GREEN), if the comment is provided by a user that is within the one or more location codes that is of interest to the first user. The pre-defined criterion includes highlighting a comment with a second color 404 (such as ORANGE), if the comment is provided by a user that is within same city of the first user but is not located in the one or more location codes that is of interest to a user. The pre-defined criterion includes highlighting a comment with a third color 406 (such as BLUE), if the comment is provided by a user from another city than that of the first user. In accordance with an embodiment, the pre-defined criterion includes highlighting a comment with a fourth color 408 (such as RED) if the comment is provided by a user from another country than that of the first user.

In accordance with an embodiment, when a user (such as the user 1047) that is located in a different location code when compared to the user 1041, comments on a post shared on the newsfeed of the user 1041, the color of the post may be in accordance with the relative location of the user 1047. For example, if the location of the user 1047 is in a different country with respect to the location of the user 1041, the comment provided by the user 1047 will be depicted in the fourth color (such as RED) when displayed in the newsfeed of the user 1041.

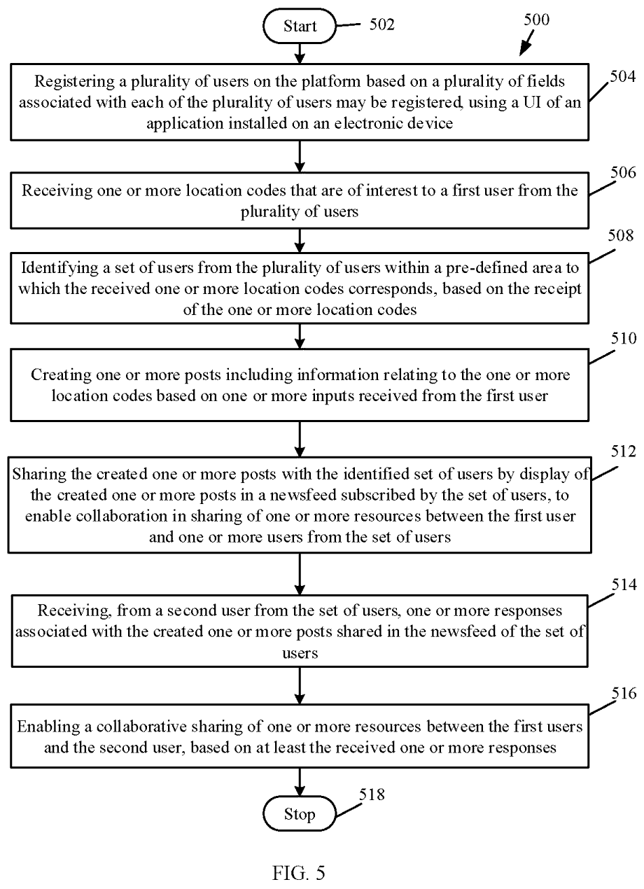

FIG. 5 is a flow diagram of a detailed exemplary process for providing a platform to enable social collaboration and resource sharing, in accordance with some embodiments of the present disclosure. With reference to FIG. 5, there is shown a flow chart 500. The flow chart 400 is described in conjunction with FIGS. 1 to 4. The process starts at step 502 and proceeds to step 504.

At step 504, using a UI of an application installed on an electronic device, a plurality of users on the platform based on a plurality of fields associated with each of the plurality of users may be registered. In accordance with an embodiment, the one or more fields includes name, age, mobile number, email address, city, locality, office location, work location, user interests, user preferences. The one or more fields may be received from the plurality of users.

At step 506, one or more location codes that are of interest to a first user from the plurality of users may be received. At step 508, a set of users from the plurality of users within a pre-defined area to which the received one or more location codes corresponds may be identified, basis the receipt of the one or more location codes. The identification may be based on a correlation of at least the one or more location codes of the first user and remaining users from the plurality of users. In accordance with an embodiment, the set of users includes local authorities, local volunteer organizations, local volunteer members, people seeking specific resources, people offering specific resources, auctioneers, bidders.

At step 510, one or more posts including information relating to the one or more location codes may be created based on one or more inputs received from the first user. In accordance with an embodiment, the one or more location codes include a postal index number (PIN) code and/or an electoral constituency code. In accordance with an embodiment, the information includes availability, quality, and quantity of one or more of: food, clothes, educational material, medicines, services, grievances of a populace, business opportunities, advertisements, one or more social causes that benefits the plurality of users, and financial assets. The one or more posts may be automatically created based on application of artificial intelligence (AI) on the received one or more inputs.

At step 512, the created one or more posts may be shared with the identified set of users by display of the created one or more posts in a newsfeed subscribed by the set of users, to enable collaboration in sharing of one or more resources between the first user and one or more users from the set of users.

At step 514, from a second user from the set of users, one or more responses associated with the created one or more posts shared in the newsfeed of the set of users, may be received. At step 516, a collaborative sharing of one or more resources between the first users and the second user may be enabled based on at least the received one or more responses. In accordance with an embodiment, the collaborative sharing includes allocation of the one or more resources from the first user to the second user, and acknowledgment provided to the first user for the allocation of the one or more resources. The control passes to end step 518.

As will be also appreciated, the above described techniques may take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

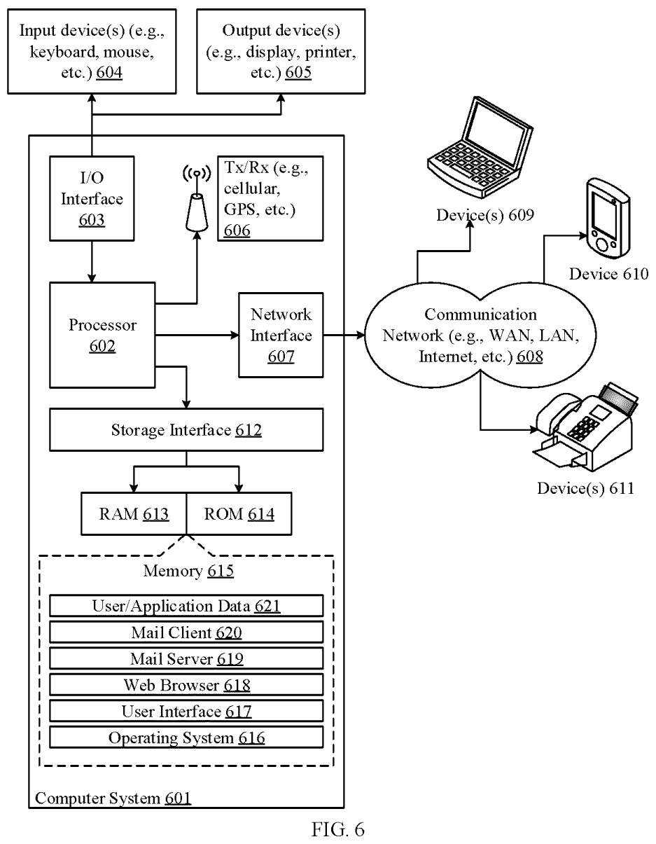

The disclosed methods and systems may be implemented on a conventional or a general-purpose computer system, such as a personal computer (PC) or server computer. Referring now to FIG. 6, a block diagram of an exemplary computer system 601 for implementing embodiments consistent with the present disclosure is illustrated. Variations of computer system 601 may be used for implementing network environment 100 for transmitting data over a communication network 108. Computer system 601 may include a central processing unit (“CPU” or “processor”) 602. Processor 602 may include at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMO Athlon, Duron or Opteron, ARM's application, embedded or secure processors, IBM PowerPC, Intel's Core, Itanium, Xeon, Celeron or other line of processors, etc. The processor 602 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 602 may be disposed in communication with one or more input/output (I/O) devices via I/O interface 603. The I/O interface 603 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 603, the computer system 601 may communicate with one or more I/O devices. For example, the input device 604 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 605 may be a printer, fax machine, video display (e.g., cathode ray tube (CRT), liquid crystal display (LCD), light-emitting diode (LED), plasma, or the like), audio speaker, etc. In some embodiments, a transceiver 606 may be disposed in connection with the processor 602. The transceiver 606 may facilitate various types of wireless transmission or reception. For example, the transceiver 606 may include an antenna operatively connected to a transceiver chip (e.g., Texas Instruments Wilink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 602 may be disposed in communication with a communication network 608 via a network interface 607. The network interface 607 may communicate with the communication network 608. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 608 may include, without limitation, a direct interconnection, local area network (LAN), wide area network (WAN), wireless network (e.g., using Wireless Application Protocol), the Internet, etc. Using the network interface 607 and the communication network 608, the computer system 601 may communicate with devices 609, 610, and 611. These devices may include, without limitation, personal computer(s), server(s), fax machines, printers, scanners, various mobile devices such as cellular telephones, smartphones (e.g., Apple iphone, Blackberry, Android-based phones, etc.), tablet computers, eBook readers (Amazon Kindle, Nook, etc.), laptop computers, notebooks, gaming consoles (Microsoft Xbox, Nintendo OS, Sony PlayStation, etc.), or the like. In some embodiments, the computer system 601 may itself embody one or more of these devices.

In some embodiments, the processor 602 may be disposed in communication with one or more memory devices (e.g., RAM 613, ROM 614, etc.) via a storage interface 612. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 616, user interface application 617, web browser 618, mail server 619, mail client 620, user/application data 621 (e.g., any data variables or data records discussed in this disclosure), etc. The operating system 616 may facilitate resource management and operation of the computer system 601. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 617 may facilitate display, execution, interaction, manipulation, or operation of program components through textual or graphical facilities. For example, user interfaces may provide computer interaction interface elements on a display system operatively connected to the computer system 601, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Java script, AJAX, HTML, Adobe Flash, etc.), or the like.

In some embodiments, the computer system 601 may implement a web browser 618 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 601 may implement a mail server 619 stored program component. The mail server may be an Internet mail server such as Microsoft Exchange, or the like. The mail server may utilize facilities such as ASP, ActiveX, ANSI C++/C#, Microsoft.NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 601 may implement a mail client 620 stored program component. The mail client may be a mail viewing application, such as Apple Mail, Microsoft Entourage, Microsoft Outlook, Mozilla Thunderbird, etc.

In some embodiments, computer system 601 may store user/application data 621, such as the data, variables, records, etc. (e.g., past ticket repository, keywords, Ngrams, clusters or categories, relationship mapping, user queries, resolutions, and so forth) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

As will be appreciated by those skilled in the art, the techniques described in the various embodiments discussed above provide connections between privileged and underprivileged users that are present within a pre-defined location. This way, users that are neighboring each other, may be able to share the resources that are surplus without requiring to discard the extra resources (such as food, clothing, and the like) available to them. The invention also enables flexible donation and sharing of the items whenever possible. For example, if a user possesses old clothing, electronics or other items, they may donate them thereby enabling creation of a unique community identity. Further, by establishing local connections, the invention allows community members to come together on a common platform and work towards the achievement of a common goal by thinking, brainstorming, and offering various perspectives to provide solutions. When a variety of knowledge and skills may be pooled, the invention enables creation of a talent pool that is vast and more competent, able and experienced. Virtual collaboration minimizes or even eliminates the need for finances and infrastructure. Furthermore, a local problem that may take months to get resolved when handled by a single individual, may take just a few hours to resolve when several other members employ their unique standpoints and expertise to get things done. These viewpoints will open up several doors to multiple ideas and solutions that a single individual may not be able to come up with.

The specification has described system and method for providing a platform to enable social collaboration and resource sharing. The disclosed invention provides a method and a system for providing a platform to enable social collaboration in a single thread in seamless manner to bring social reform by addressing grievances and empowering each of the users of the platform, such as the common man.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope of disclosed embodiments being indicated by the following claims.

What is claimed is:

1. A method for providing a platform to enable social collaboration and resource sharing, the method comprising:
registering, via a user interface (UI) of an application installed on an electronic device, a plurality of users on the platform based on a plurality of fields associated with each of the plurality of users;
receiving, by the electronic device, one or more location codes that are of interest to a first user from the plurality of users;
identifying, by the electronic device, a set of users from the plurality of users within a pre-defined area to which the received one or more location codes corresponds, wherein the identification is based on a correlation of at least the one or more location codes of the first user and remaining users from the plurality of users;
creating, by the electronic device, based on one or more inputs received from the first user, one or more posts comprising information relating to the one or more location codes, wherein the one or more posts are automatically created based on application of artificial intelligence (AI) on the received one or more inputs;
sharing, by the electronic device, the created one or more posts with the identified set of users by display of the created one or more posts in a newsfeed subscribed by the set of users, to enable collaboration in sharing of one or more resources between the first user and one or more users from the set of users;
receiving, by the electronic device, from a second user from the set of users, one or more responses associated with the created one or more posts shared in the newsfeed of the set of users; and
enabling, by the electronic device, a collaborative sharing of one or more resources between the first users and the second user based on at least the received one or more responses.

2. The method as claimed in claim 1, wherein the collaborative sharing comprises: allocation of the one or more resources from the first user to the second user; and
acknowledgment provided to the first user for the allocation of the one or more resources.

3. The method as claimed in claim 2, wherein the acknowledgement comprises monetary compensation provided to the first user for the allocated resources, wherein the compensation is one or more of: a monetary compensation, a gamified compensation.

4. The method as claimed in claim 3, comprising integrating one or more payment gateways with the platform for settlement of compensation and/or raising funds from the plurality of users, which can be utilized to resolve one or more complaints raised by the plurality of users.

5. The method as claimed in claim 1, wherein the information comprises availability, quality, and quantity of one or more of: food, clothes, educational material, medicines, services, grievances of a populace, business opportunities, advertisements, one or more social causes that benefits the plurality of users, and financial assets, wherein the one or more fields comprises name, age, mobile number, email address, city, locality, office location, work location, user interests, user preferences, and wherein the one or more fields are received from the plurality of users.

6. The method as claimed in claim 1, wherein the set of users comprises local authorities, local volunteer organizations, local volunteer members, people seeking specific resources, people offering specific resources, auctioneers, bidders.

7. The method as claimed in claim 1, comprising creating, by the electronic device, one or more polling requests to obtain the one or more inputs from the plurality of users.

8. The method as claimed in claim 1, wherein the one or more posts comprise a social media campaign for enabling donation of one or more items, wherein the one or more posts comprise multimedia content and metadata associated with the one or more items, and wherein the one or more items for donation are indexed to enable searching of the one or more items on the UI by the plurality of users, based on one or more of: keywords, user utterances, images, gestures.

9. The method as claimed in claim 1, wherein the one or more posts comprise an SOS message comprising location code of the first user, generated for one or more authorities for providing emergency services to the first user, and wherein the one or more authorities comprise law enforcement agency and medical service agency.

10. The method as claimed in claim 9, wherein the collaborative sharing between the first user and the second user comprises sharing the details of the one or more authorities that can provide emergency services to the first user.

11. The method as claimed in claim 1, wherein the one or more location codes comprise a postal index number (PIN) code and/or an electoral constituency code.

12. The method as claimed in claim 1, further comprising receiving one or more comments from the set of users on at least one of the one or more posts,
wherein a color coding mechanism is utilized to display the one or more comments based on a pre-defined criteria, wherein the pre-defined criterion comprises at least one of:
highlighting a comment with a first color, if the comment is provided by a user that is within the one or more location codes that is of interest to the first user;
highlighting a comment with a second color, if the comment is provided by a user that is within same city of the first user but is not located in the one or more location codes that is of interest to a user;
highlighting a comment with a third color, if the comment is provided by a user from another city than that of the first user; or
highlighting a comment with a fourth color if the comment is provided by a user from another country than that of the first user.

13. The method as claimed in claim 1, further comprising providing one or more action buttons associated with each of the one or more posts, wherein a user from the set of users clicks on the one or more actions buttons to like, dislike, share, comment on the one or more posts.

14. The method as claimed in claim 1, further comprising providing an option to the plurality of users to publish the one or more posts to PIN codes, city, and country, continents that are different from that of the plurality of users.

15. A system for providing a platform to enable social collaboration and resource
sharing, the system comprising:
a plurality of electronic devices, each associated with a user from a plurality of users;
an application installed on each of the plurality of electronic devices, wherein the application comprises a user interface (UI) of the platform and the application performs:
registration of a plurality of users on the platform based on a plurality of fields associated with each of the plurality of users;
receipt of one or more location codes that are of interest to a first user from the plurality of users;
identification of a set of users from the plurality of users within a pre-defined area to which the received one or more location codes corresponds, wherein the identification is based on a correlation of at least the one or more location codes of the first user and remaining users from the plurality of users;
creation, based on one or more inputs received from the first user, of one or more posts comprising information relating to the one or more location codes, wherein the one or more posts are automatically created based on application of artificial intelligence (AI) on the received one or more inputs;
sharing of the created one or more posts with the identified set of users by display of the created one or more posts in a newsfeed subscribed by the set of users, to enable collaboration in sharing of one or more resources between the first user and one or more users from the set of users;
receipt, from a second user from the set of users, of one or more responses associated with the created one or more posts shared in the newsfeed of the set of users; and enablement of a collaborative sharing of one or more resources between the first users and the second user based on at least the received one or more responses.
